(19) United States
(12) Patent Application Publication
(10) Pub. No.: US 2024/0154480 A1
(43) Pub. Date: May 9, 2024

(54) MAGNETIC ROTOR INCLUDING NON-MAGNETIC MAGNET RETENTION RINGS

(71) Applicant: BorgWarner Inc., Auburn Hills, MI (US)

(72) Inventor: James J. Ramey, Fortville, IN (US)

(21) Appl. No.: 17/983,833

(22) Filed: Nov. 9, 2022

(51) Int. Cl. H02K 1/28; H02K 1/32

(52) U.S. Cl. CPC H02K 1/28; H02K 1/32

(57) ABSTRACT

A rotor for an electric machine including a rotor hub. A plurality of laminations is mounted to the rotor hub. The plurality of laminations include a first axial end and a second axial end. A plurality of magnets extend axially through the plurality of laminations between the first axial end and the second axial end. A magnet retention ring is mounted at one of the first axial end and the second axial end of the plurality of laminations. The magnet retention ring includes an axial inner surface, a plurality of magnet retention members projecting axially of the axial inner surface, and a plurality of vanes projecting axially of the axial inner surface. The plurality of magnet retention members engage corresponding ones of the plurality of magnets and the plurality of vanes direct a cooling fluid through the plurality of laminations when the rotor is in operation.

### BACKGROUND OF THE INVENTION

Exemplary embodiments pertain to the art of electric machines and, more particularly, to a magnetic rotor having non-magnetic magnet retention rings for an electric machine.

Rotors for electric machines typically include a central annular support upon which are arranged a plurality of laminations that form a lamination stack. The each lamination includes a plurality of openings. The plurality of openings for each lamination are aligned one with another to form magnet receiving zones. Magnets are arranged in each opening. The magnets extend through the lamination stack in an axial direction. Typically, the magnets are rare earth magnets having a high magnetic force. The high magnetic force generate tends to push the magnets axially outwardly from the lamination stack. Accordingly, there are various methods for retaining the magnets in the lamination stack.

End rings were often used to retain magnets in a lamination stack. The end rings may have been formed from a non-magnetic metal such as stainless steel or aluminum or they may have been formed from plastic. Metal or non-metal end rings present various assembly issues. Metal end rings need to be machined, balanced, and secured to the rotor hub. Non-metal or plastic end rings are often attached by heat staking. Both methods are time consuming. Mechanisms, such as epoxy and cyanoacrylate adhesives have also been used. However, adhesives have not proven to be affective over a service life of a rotor. Accordingly, the industry would welcome new systems for constraining magnets in a rotor stack.

### BRIEF DESCRIPTION OF THE INVENTION

Disclosed is a rotor for an electric machine including a rotor hub having a lamination support. A plurality of laminations is mounted to the lamination support. The plurality of laminations include a first axial end and a second axial end that is opposite the first axial end. A plurality of magnets extend axially through the plurality of laminations between the first axial end and the second axial end. A magnet retention ring is mounted at one of the first axial end and the second axial end of the plurality of laminations. The magnet retention ring includes an axial inner surface, a plurality of magnet retention members projecting axially of the axial inner surface, and a plurality of vanes projecting axially of the axial inner surface. The plurality of magnet retention members engage corresponding ones of the plurality of magnets and the plurality of vanes direct a cooling fluid through the plurality of laminations when the rotor is in operation.

Also disclosed is an electric machine including a housing having an inner surface. A stator fixedly connected to the inner surface and a rotor is rotatably supported in the housing radially inwardly of the stator. The rotor includes a rotor hub having a lamination support. A plurality of laminations is mounted to the lamination support. The plurality of laminations include a first axial end and a second axial end that is opposite the first axial end. A plurality of magnets extend through the plurality of laminations between the first axial end and the second axial end. A magnet retention ring is mounted at one of the first axial end and the second axial end of the plurality of laminations. The magnet retention ring includes an axial inner surface, a plurality of magnet retention members projecting axially of the axial inner surface, and a plurality of vanes projecting axially of the axial inner surface. The plurality of magnet retention members engage corresponding one of the plurality of magnets and the plurality of vanes directing a cooling fluid through the plurality of laminations when the rotor is in operation.

### BRIEF DESCRIPTION OF THE DRAWINGS

The following descriptions should not be considered limiting in any way. With reference to the accompanying drawings, like elements are numbered alike:

FIG. 1 depicts a partial cross-sectional elevational view of an electric machine including a rotor having non-magnetic magnet retention rings, in accordance with a non-limiting example;

FIG. 2 depicts a perspective view of the rotor having non-magnetic magnet retention rings, in accordance with a non-limiting example;

FIG. 3 depicts a disassembled view of the rotor of FIG. 2, in accordance with a non-limiting example;

FIG. 4 is a cross-sectional view of the rotor of FIG. 2 taken through the line 4-4, in accordance with a non-limiting example;

FIG. 5 a perspective view of an outer surface of a non-magnetic magnet retention ring, in accordance with a non-limiting example;

FIG. 6 depicts a perspective view of an inner surface of the non-magnetic magnet retention ring of FIG. 5, in accordance with a non-limiting example;

FIG. 7 is a partial perspective view of non-magnetic magnet retention ring, in accordance with another non-limiting example;

FIG. 8 depicts a partial cross-sectional elevational view of a rotor having non-magnetic magnet retention rings, in accordance with another non-limiting example; and

FIG. 9 is a partial perspective view of non-magnetic magnet retention ring, in accordance with yet another non-limiting example.

### DETAILED DESCRIPTION OF THE INVENTION

A detailed description of one or more embodiments of the disclosed apparatus and method are presented herein by way of exemplification and not limitation with reference to the Figures.

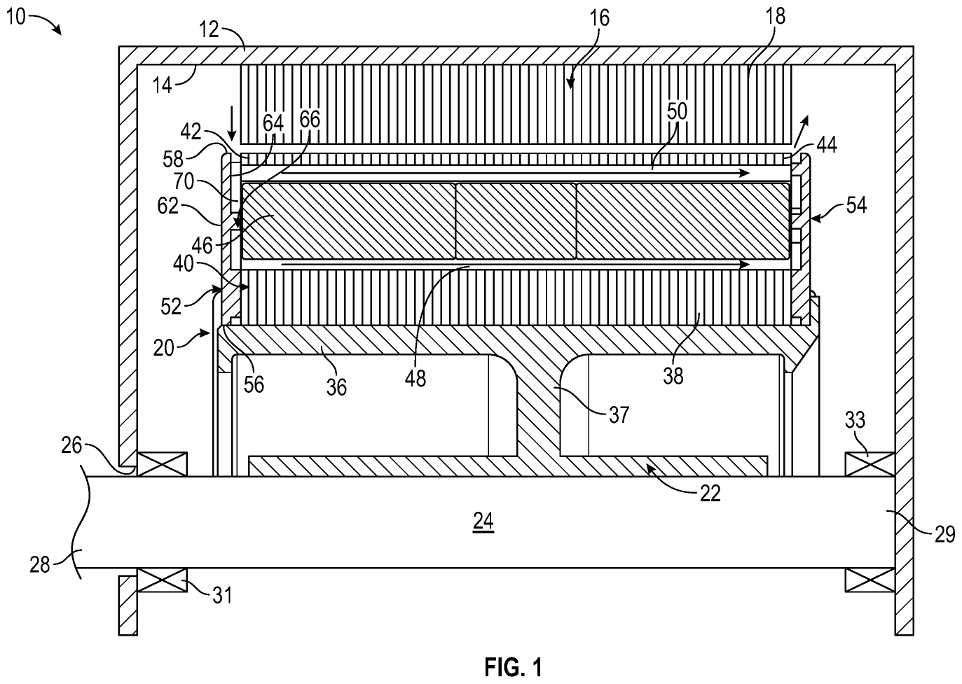

An electric machine, in accordance with a non-limiting example, is indicated generally at 10 in FIGS. 1, 2, and 3. Electric machine 10 includes a housing 12 having an inner surface 14. A stator 16 is arranged in housing 12 and fixedly connected to inner surface 14. Stator 16 is formed from a plurality of stator laminations 18. A rotor 20 is rotatably supported in housing 12. Rotor 20 includes a rotor hub 22 supported on a rotor shaft 24. Rotor shaft 24 extends through an opening 26 in housing 12 and includes a first end 28 and a second end 29. First end 28 extends through opening 26 and is supported by a first bearing 31 and second end 29 is supported in housing 12 by a second bearing 33.

In a non-limiting example, rotor hub 22 includes a lamination support 36. Lamination support 36 is connected to rotor hub 22 by a web 37. A plurality of rotor laminations 38 is arranged on lamination support 36. Plurality of rotor laminations 38 form a lamination stack 40 having a first axial end 42 and a second axial end 44. A plurality of magnets 46 are arranged in rotor laminations 38. Plurality of magnets 46 extend axially through lamination stack 40 from first axial end 42 to second axial end 44. Due to tolerancing, magnets 46 may extend axially through rotor laminations 38 and end up short of first axial end 42 and second axial end 44. A first coolant passage 48 extends axially through lamination stack 40 radially inwardly of plurality of magnets 46 and a second coolant passage 50 extends through lamination stack 40 radially outwardly of plurality of magnets 46.

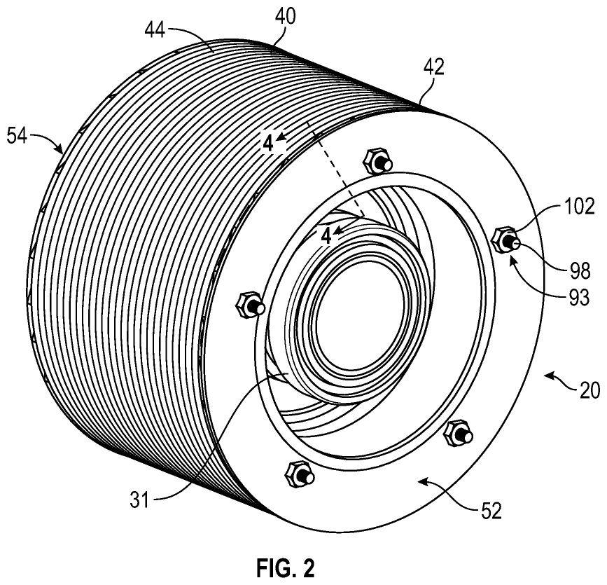

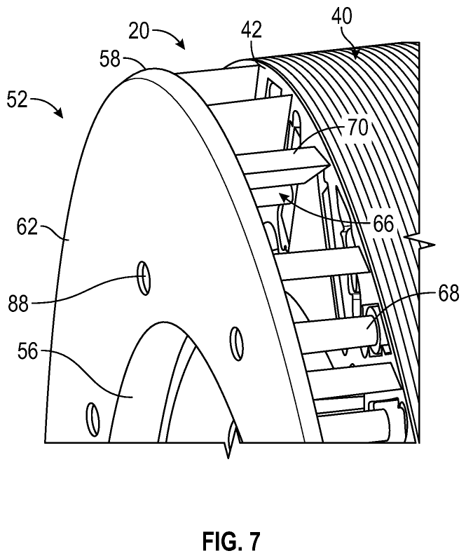

Referring to FIGS. 2, 3, and 4, rotor 20 includes a first magnet retention ring 52 arranged at first axial end 42 of lamination stack 40 and a second magnet retention ring 54 arranged at second axial end 44 of lamination stack 40. Reference will follow to FIGS. 5, 6, and 7 in describing first magnet retention ring 52 with an understanding that second magnet retention ring 54 includes similar structure. First magnet retention ring 52 includes an inner annular edge 56 and an outer annular edge 58, an axial outer surface 62 (FIG. 5) and an axial inner surface 64 (FIG. 6). In a non-limiting example, a plurality of magnet retaining members 66 shown in the form of posts 68 (FIG. 6) project axially outwardly of axial inner surface 64 and engage magnets 46 as shown in FIGS. 1, 4, and 7. A plurality of vanes 70 are formed on and project axially outwardly of axial inner surface 64.

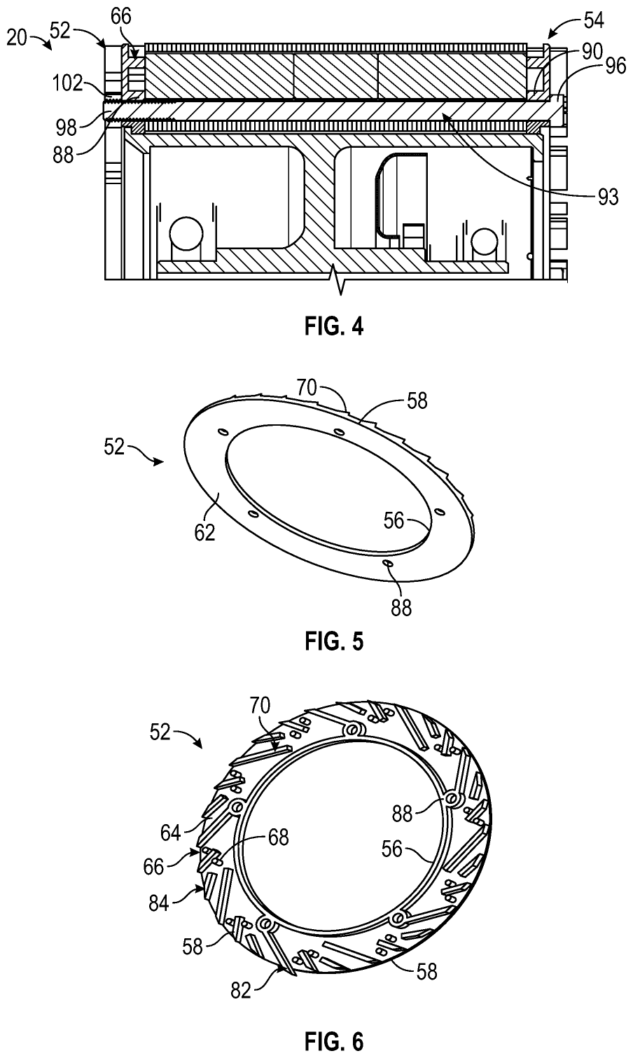

In a non-limiting example, plurality of vanes 70 extend from outer annular edge 58 toward inner annular edge 56 at a non-zero angle. In a non-limiting example, plurality of vanes 70 include a first plurality of vanes 82 having a first length and a second plurality of vanes 84 having a second length that is less than the first length. As shown in FIG. 6 select ones of the second plurality of vanes 84 extend between adjacent ones of the plurality of magnet retention members 66. When first and second magnet retention rings 52 and 54 are mounted to rotor 20 (FIG. 4), magnet retention members 66 ensure that magnets 46 to not shift axially outwardly and vanes 70 develop a cooling fluid flow (such as but not limited to air, oil or other gases and liquids) that may pass through first and second coolant passages 48 and 50 to lower operating temperatures of electric machine 10.

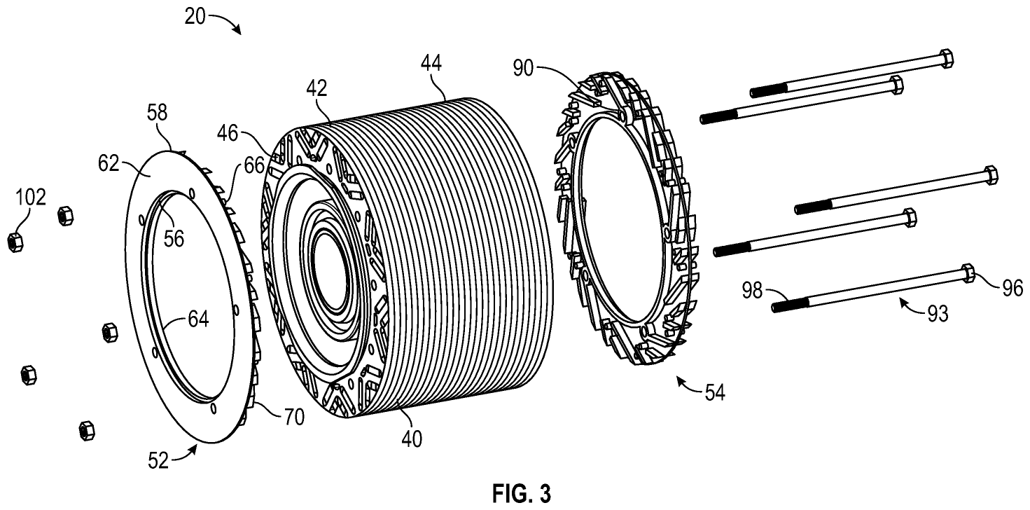

In addition, first magnet retention ring 52 includes a plurality of connector lugs 88 arrayed about axial inner surface 64 radially outwardly of inner annular edge 56. Second magnet retention ring 54 includes a plurality of mounting lugs 90 arranged in a similar manner. Connector lugs 88 and mounting lugs 90 are employed to secure first magnet retention ring 52 and second magnet retention ring 54 to rotor 20 at corresponding ones of first and second axial ends 42 and 44 of lamination stack 40. In a non-limiting example, a plurality of fasteners, indicated generally at 93 in FIG. 3 pass into mounting lugs 90 in second magnet retention ring 54, pass through lamination stack 40 and exit from connector lugs 88 in first magnet retention ring 52. Fasteners 93 include a head end 96 and a threaded end 98. A nut 102 is connected to the threaded end 98 of each fastener 93 and tightened to a prescribed torque.

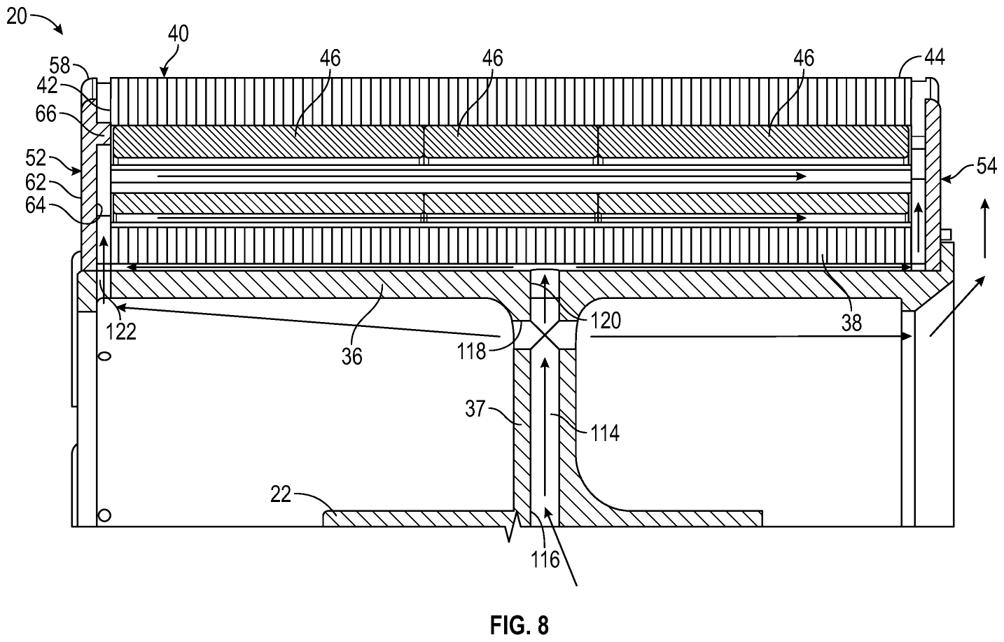

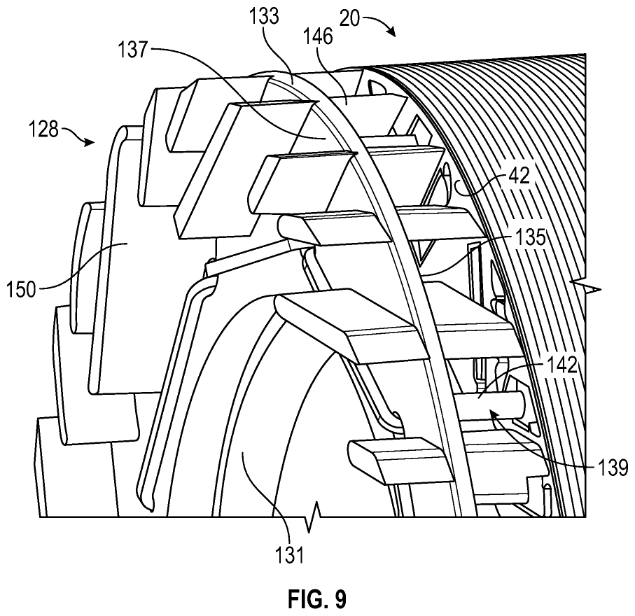

Reference will now turn to FIG. 8, wherein like reference numbers represent corresponding parts in the respective views while describing rotor hub 22 in accordance with another non-limiting example. Rotor hub 22 includes a coolant passage portion 114 extending through web 37. Coolant passage portion 114 includes an inlet 116, a first outlet 118 formed in web 37 and a second outlet 120 in lamination support 36. Lamination support 36 also includes an opening 122 arranged at first axial end 42 of lamination stack 40. Rotation of rotor 20 causes vanes 70 to generate a cooling fluid flow. The cooling fluid flow may pass through coolant passage portion 114 and flow through first outlet 118 into opening 122 and from second outlet 120 into first and second coolant passages 48 and 50 to reduce operational temperatures of electric machine 10.

A magnet retention ring 128 in accordance with another non-limiting example is shown in FIG. 9. Magnet retention ring 128 includes an inner annular edge 131, an outer annular edge 133, an inner axial surface 135 and an outer axial surface 137. A plurality of magnet retention members 139 shown in the form of posts 142 project axially outwardly from inner axial surface 135. In addition, a first plurality of vanes 146 project axially outwardly from inner axial surface 135. A second plurality of vanes 150 project axially outwardly form outer axial surface 137. First plurality of vanes 148 deliver a cooling fluid flow into rotor 20 while second plurality of vanes 150 generate a cooling fluid flow within housing 12 to cool, for example, stator 16, first bearing 31 and second bearing 33.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A rotor for an electric machine comprising:
a rotor hub including a lamination support;
a plurality of laminations mounted to the lamination support, the plurality of laminations including a first axial end and a second axial end that is opposite the first axial end;
a plurality of magnets extending axially through the plurality of laminations between the first axial end and the second axial end; and
a magnet retention ring mounted at one of the first axial end and the second axial end of the plurality of laminations, the magnet retention ring including an axial inner surface, a plurality of magnet retention members projecting axially of the axial inner surface, and a plurality of vanes projecting axially of the axial inner surface,
the plurality of magnet retention members engaging corresponding ones of the plurality of magnets; and
the plurality of vanes directing a cooling fluid through the plurality of laminations when the rotor is in operation.

2. The rotor according to claim 1, wherein the magnet retention ring includes an outer annular edge and an inner annular edge, the plurality of vanes extending from the outer annular edge toward the inner annular edge.

3. The rotor according to claim 2, wherein the plurality of vanes extend from the outer annular edge across the axial inner surface at a non-zero angle.

4. The rotor according to claim 2, wherein the plurality of vanes includes a first plurality of vanes having a first length a second plurality of vanes having a second length that is less than the first length.

5. The rotor according to claim 2, wherein each of the plurality of vanes include a first end, a second end, the second end terminating at the outer annular edge.

6. The rotor according to claim 5, wherein the first end of each of the plurality of vanes is spaced from the inner annular edge.

7. The rotor according to claim 1, wherein the plurality of magnet retention members comprise posts that project axially outwardly from the axial inner surface.

8. The rotor according to claim 1, wherein the magnet retention ring includes a first magnet retention ring including a first plurality of vanes arranged at the first axial end of the plurality of laminations and a second magnet retention ring including a second plurality of vanes arranged at the second axial end of the plurality of laminations.

9. The rotor according to claim 8, wherein the plurality of laminations includes at least one coolant passage extending between the first axial end and the second axial end the first plurality of vanes generating a first cooling fluid flow into the at least one coolant passage and the second plurality of vanes generating a second cooling fluid flow from the at least one coolant passage.

10. The rotor according to claim 9, wherein the rotor hub includes a coolant passage portion fluidically connected with the at least one coolant passage extending through the plurality of laminations.

11. An electric machine comprising:
a housing including an inner surface;
a stator fixedly connected to the inner surface; and
a rotor rotatably supported in the housing radially inwardly of the stator, the rotor including:
a rotor hub including a lamination support;
a plurality of laminations mounted to the lamination support, the plurality of laminations including a first axial end and a second axial end that is opposite the first axial end;
a plurality of magnets extending through the plurality of laminations between the first axial end and the second axial end; and
a magnet retention ring mounted at one of the first axial end and the second axial end of the plurality of laminations, the magnet retention ring including an axial inner surface, a plurality of magnet retention members projecting axially of the axial inner surface, and a plurality of vanes projecting axially of the axial inner surface,
the plurality of magnet retention members engaging corresponding one of the plurality of magnets; and
the plurality of vanes directing a cooling fluid through the plurality of laminations when the rotor is in operation.

12. The electric machine according to claim 11, wherein the magnet retention ring includes an outer annular edge and an inner annular edge, the plurality of vanes extending from the outer annular edge toward the inner annular edge.

13. The electric machine according to claim 12, wherein the plurality of vanes extend from the outer annular edge across the axial inner surface at a non-zero angle.

14. The electric machine according to claim 12, wherein the plurality of vanes includes a first plurality of vanes having a first length a second plurality of vanes having a second length that is less than the first length.

15. The electric machine according to claim 12, wherein each of the plurality of vanes includes a first end and a second end, the second end terminating at the outer annular edge.

16. The electric machine according to claim 15, wherein the first end of each of the plurality of vanes is spaced from the inner annular edge.

17. The electric machine according to claim 11, wherein the plurality of magnet retention members comprise posts that project axially outwardly from the axial inner surface.

18. The electric machine according to claim 11, wherein the magnet retention ring includes a first magnet retention ring including a first plurality of vanes arranged at the first axial end of the plurality of laminations and a second magnet retention ring including a second plurality of vanes arranged at the second axial end of the plurality of laminations.

19. The electric machine according to claim 18, wherein the plurality of laminations includes at least one coolant passage extending between the first axial end and the second axial end the first plurality of vanes generating a first cooling fluid flow into the at least one coolant passage and the second plurality of vanes generating a second cooling fluid flow from the at least one coolant passage.

20. The electric machine according to claim 19, wherein the rotor hub includes a coolant passage portion fluidically connected with the at least one coolant passage extending through the plurality of laminations.
